(19) United States
(12) Patent Application Publication
(10) Pub. No.: US 2025/0296614 A1
(43) Pub. Date: Sep. 25, 2025

(54) Convertible Mattress Dolly

(71) Applicant: Tony J. Ballew, Livingston, MT (US)

(72) Inventor: Tony J. Ballew, Livingston, MT (US)

(21) Appl. No.: 19/088,994

(22) Filed: Mar. 25, 2025

Related U.S. Application Data
(60) Provisional application No. 63/569,166, filed on Mar. 24, 2024.

(51) Int. Cl. B62B 3/10; A45F 5/10; B62B 3/02; B62B 3/04; B62B 5/00; B62B 5/06

(52) U.S. Cl. CPC B62B 3/108; A45F 5/10; B62B 3/022; B62B 3/04; B62B 5/0083; B62B 5/06; B62B 2202/30

(57) ABSTRACT

A first dolly fitted with a minimum of one engagement boss that securely registers with features of an auxiliary dolly. Vertical trusses joined to a horizontal deck of the first dolly are spaced to support and retain a mattress in a vertical, upright orientation between the trusses. A portion of at least one truss provides a handle for an individual to lift and carry a captive mattress, or to maneuver the dolly and mattress onto the auxiliary dolly. Alternative embodiments provide structure for adjusting a distance between trusses to accommodate a range of mattress thicknesses, and a hinge embodiment provides for folding of the trusses. Additional embodiments provide structure for an adjustment of the dolly boss or bosses to positively engage with a range of auxiliary dolly sizes and features. A dolly latch embodiment provides an even greater deterrent to a separation of the first dolly from the auxiliary dolly.

### CROSS-REFERENCE TO RELATED APPLICATIONS

This application claims the benefit of multiple provisional patent applications:
Application No. 63/569,166 filed on Mar. 24, 2024;
Application No. 63/572,049 filed on Mar. 29, 2024;
Application No. 63/664,933 filed on Jun. 27, 2024;
Application No. 63/667,912 filed on Jul. 5, 2024;
Application No. 63/671,261 filed on Jul. 14, 2024; and
Application No.; 62/672,762 filed on Jul. 18, 2024; all filed by applicant, Tony Ballew.

### FEDERALLY SPONSORED RESEARCH OR DEVELOPMENT

Not Applicable

### NAMES OF PARTIES TO A JOINT RESEARCH AGREEMENT

Not Applicable

### INCORPORATION-BY-REFERENCE OF MATERIAL SUBMITTED ON A READ-ONLY OPTICAL DISC, AS A TEXT FILE OR AN XML FILE VIA THE PATENT ELECTRONIC SYSTEM

Not Applicable

### BACKGROUND OF THE INVENTION—Field of the Invention

This invention relates to dollies and hand trucks and particularly to a dolly for enhancing the handling and movement of mattresses, box springs, and mattress foundations.

### BACKGROUND OF THE INVENTION—Background Art

The handling and transport of mattresses has long been difficult due to their bulk. This difficulty is especially pronounced when only one person is present to move the mattress. With larger mattresses and with the introduction of memory foam mattresses, which are much heavier and far less rigid than many other styles of mattresses, the challenges of moving a mattress by oneself have become even more significant.

Several inventions have attempted to address the difficulties of moving a mattress, but until now, each has had particular limitations that render them less than effective. One of these inventions (FIG. 1), U.S. Pat. No. 4,431,226 to Weilert (1984), is a pair of wide straps that wrap around a mattress and provide handles by which to grasp a mattress. Weilert teaches that its use better enables two people to move a mattress, and that its straps adjust for any size of mattress. However, if a mattress must be left unattended during transit, to avoid laying it on the ground or taking up additional space on a floor, a suitable and predominantly unobstructed structure must be located against which to rest such a mattress. For only one individual to use Wielert, its straps would require careful placement and potential readjustment to provide a proper “center-of-gravity” orientation of its handles. In addition, the use of Weilert by one person over long distances could be a substantial limitation or hindrance for many of its users.

Another invention (FIG. 2), U.S. Pat. No. 5,120,072 to Laramie (1992) is a wheeled dolly for transporting longitudinal objects such as mattresses. Laramie provides a narrow base upon which a mattress can rest, and three wheels beneath the base. The wheels are oriented in line along a longitudinal axis of its base. Although Laramie overcomes the requirements for Weilert's unattended mattress by providing a kickstand whereby an unattended mattress might remain in a substantially upright orientation, the orientation of Laramie's swivel and fixed wheels requires careful vertical balance of the mattress during transport. Even more care is required when additional, longitudinal tilting of the dolly is needed in order to engage the slightly smaller swivel wheel so that the dolly can be steered, such as when navigating around a corner.

In addition to Laramie's need for specific balance and wheel engagement during various transport scenarios, its in-line wheel orientation only allows for longitudinal or rotational mattress movement. Although its one swivel caster provides limited steering capability, a lateral movement perpendicular to the longitudinal axis of its fixed caster wheels is disallowed. Such inability of lateral movement restricts exact navigation and placement of a mattress, and further makes an intended transfer of a mattress directly from the dolly and onto a bed frame more difficult. In effect, Laramie is dedicated to longitudinal movement of longitudinal objects.

Although Laramie provides for casier transport of a mattress by one, unassisted individual, it is largely limited to movement over smooth, flat surfaces and is impractical for use over rough terrain, snow, or mud. In some transport scenarios, Laramie's protrusion of wheels pose a safety concern by way of unintentional rolling or snagging. In short, it appears that Laramie neither anticipates nor provides for transport of a mattress over any surfaces other than those that are substantially smooth, hard, and flat.

Another style of dolly, U.S. Patent Application Publication 2005/0040618 to Beatty (2005) also describes a dolly for the transport of items such as mattresses. Beatty's quantity and orientation of wheels (FIG. 3) eliminates the need for its user to balance articles on the dolly during transport. Beatty also facilitates one-person transport of a mattress, and it provides a means for unassisted support of a mattress in a substantially vertical orientation. However, Beatty is limited to longitudinal and rotational movement of objects due to “two of said wheels having axes of their rotation fixed with respect to said base.” Lateral movement of objects perpendicular to Beatty's fixed wheel axes is therefore disallowed.

In some transport scenarios, Beatty's protrusion of wheels, like those of Laramie, pose a safety concern by way of unintentional rolling or snagging. Beatty's features and specification indicate that it neither anticipates nor provides for transport of mattresses over rough or difficult terrain, or terrain other than that which is primarily flat, hard, and smooth.

Another invention, U.S. Pat. No. 6,422,152 to Rowe (2002) teaches a sliding dolly “particularly adapted” for mattress movement inside a truck during a process of transferring mattresses onto or off of a forklift. Rowe (FIG. 4) utilizes two, repositionable wheels that, when oriented in a horizontal plane position, provide for rolling along an inside sidewall surface of a truck box, and that, when oriented in a vertical plane position, provide for longitudinal rolling on a truck box floor. Rowe is designed to work in tandem with a longitudinal slider that is mounted inside of the truck box. The centerline axis of its two wheels are oriented parallel to the dolly's longitudinal axis (also being ultimately parallel to the truck's slider). This wheel orientation and slider combination does not provide for (and has no need for) “steering” capabilities or lateral dolly movement perpendicular to its centerline wheel axis. It is primarily designed for longitudinal, “fore and aft” movement of mattresses inside a truck box where steering is unnecessary.

As noted, mattress movement over longer distances as well as over rough or difficult terrain is regularly required during a single move. The need to allow multi-directional mattress movement, to enhance user capabilities and reduce effort, to ensure a secure grasp of the mattress, to maintain specific and safe center-of-gravity control, to eliminate any potential for snagging, and to provide an ability to readily adjust the angle of the mattress to adequately accommodate a given pitch of various terrain has, until now, been under-appreciated. Currently, no prior art equipment or methods have been found that are able to overcome or accommodate the noted difficulties and transport scenarios commonly associated with the movement of a mattress, box spring, or mattress foundation.

### BACKGROUND OF THE INVENTION—Objects and Advantages

Accordingly, several objects and advantages of my convertible mattress dolly are to provide a means of transporting mattresses and mattress foundations by one person, and that
(a) is suitable for object transport over long distances of substantially flat or smooth surfaces,
(b) is convertible for transport over rough or difficult terrain,
(c) provides ease of adjustment for proper center-of-gravity control,
(d) provides ease of adjustment to accommodate a given pitch of terrain,
(e) is capable of being separated from unwanted protrusions, as needed,
(f) is capable of eliminating unwanted dolly rolling, as needed,
(g) provides mattress stability during wheeled transport,
(h) provides unassisted support of a mattress in a substantially vertical, upright orientation,
(i) provides for multi-directional movement during wheeled transport, including lateral, longitudinal, and diagonal movement, and that
(j) facilitates mattress, box spring, and foundation removal from or placement onto a bed frame.

Additional advantages of my mattress dolly are that it
(k) provides for a secure grasp of a mattress, box spring, or foundation,
(l) is capable of being separated from unnecessary weight, as needed, and that it
(m) provides for versatility of companion equipment.

Further objects and advantages of my mattress dolly will become apparent from a consideration of the drawings and ensuing description.

### BRIEF SUMMARY OF THE INVENTION

A mattress dolly for moving a mattress that is adaptable for use over smooth surfaces as well as over rough terrain. The dolly's trusses are designed to contain a mattress and to provide a means whereby a mattress may be lifted, carried, and maneuvered by one individual over rough or difficult terrain. For easier transport when smooth, hard, or level terrain is encountered, location bosses joined to the dolly allow the dolly to be specifically placed onto an auxiliary furniture dolly so that an unintentional lateral shift between the mattress dolly and the furniture dolly is precluded. One embodiment further includes a latch that is mounted to the mattress dolly. The latch is capable of engagement with the furniture dolly so that the mattress dolly and furniture dolly are selectively and even more positively joined to one another. This enhanced connectivity assures that a vertical separation between the dollies is also precluded.

### BRIEF DESCRIPTION OF THE SEVERAL VIEWS OF THE DRAWINGS

FIG. 1—Prior art; Weilert

FIG. 2—Prior art; Laramie

FIG. 3—Prior art; Beatty

FIG. 4—Prior art; Rowe

FIG. 5—Preferred Embodiment

FIG. 6A—End view of side rails

FIG. 6B—Perspective view of side rails

FIG. 7A—Latch actuator

FIG. 7B—Latch side view

FIG. 7C—Latch exploded view

FIG. 7D—Alternative dolly latch; adjustable

FIG. 8A—Dolly mounted; pre-adjustment

FIG. 8B—Dolly mounted; boss adjusted

FIG. 9A—Mattress mounting

FIG. 9B—mattress mounted, upright

FIG. 10—Alternative shuttle and shuttle lock

FIG. 11A—Ratcheting shuttle lock

FIG. 11B—Ratchet lock; unlatched

FIG. 12—Alternative mattress dolly

FIG. 13A—Hinge, exploded

FIG. 13B—Hinge, collapsed

FIG. 13C—Hinge, upright

FIG. 14A—Self-adjusting plate latch

FIG. 14B—Plate latch exploded

FIG. 15A—Plate latch; passive action

FIG. 15B—Latch on thin main rail

FIG. 15C—Latch on thick main rail

FIG. 15D—Latch-retraction

FIG. 16—Alternative dolly; folded

FIG. 17A—Dolly pre-adjustment

FIG. 17B—Dolly adjusted

FIG. 18—Alternative dolly latch

FIG. 19A—Alternative pocket latch

FIG. 19B—Pocket latch engaged

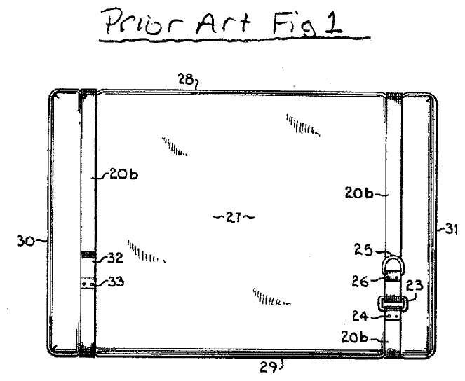

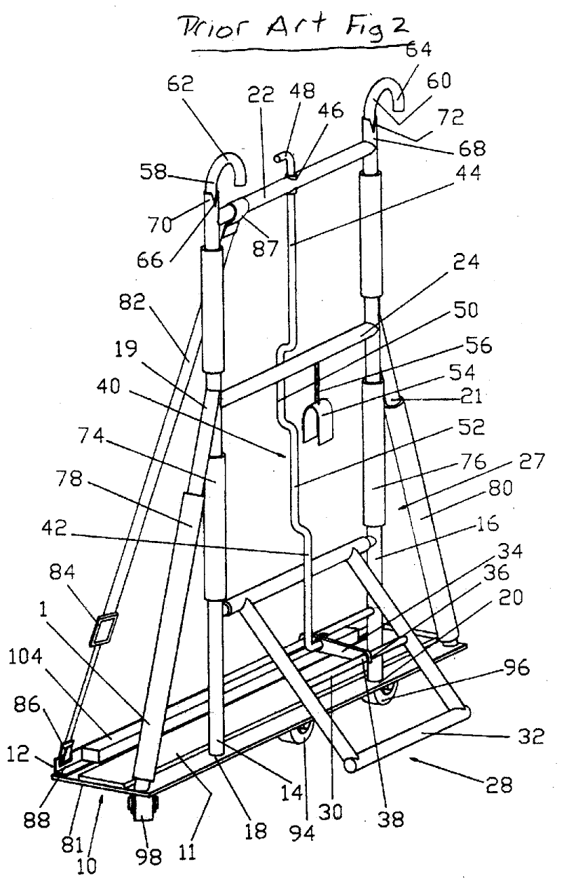

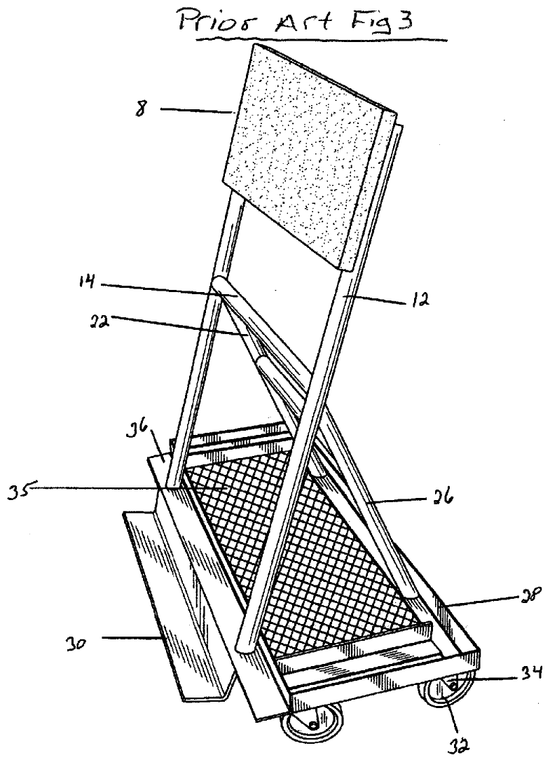

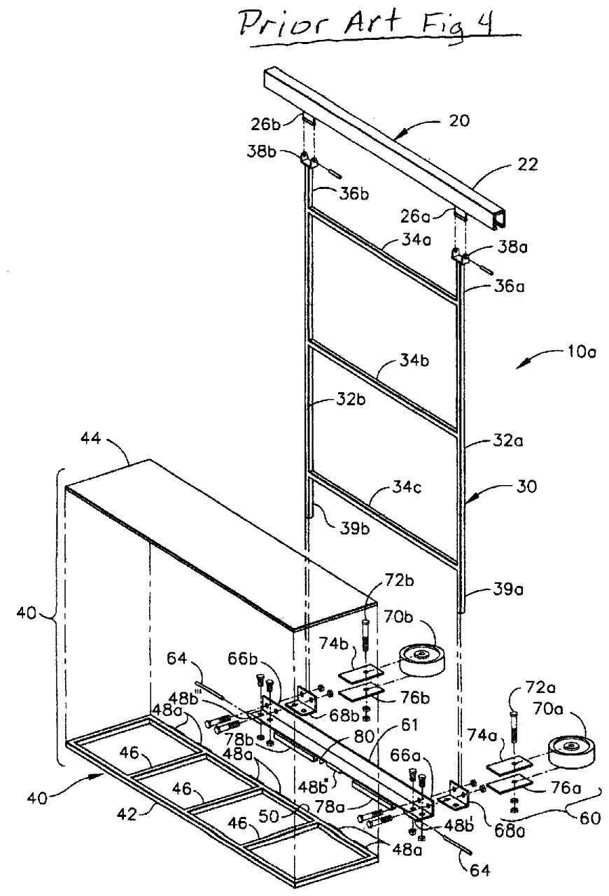

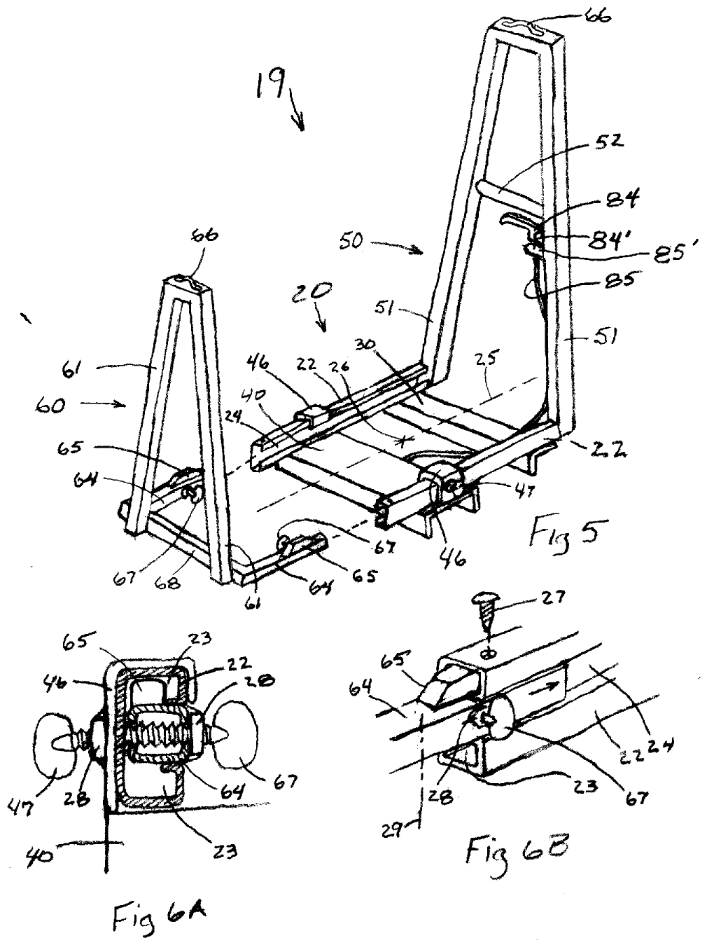

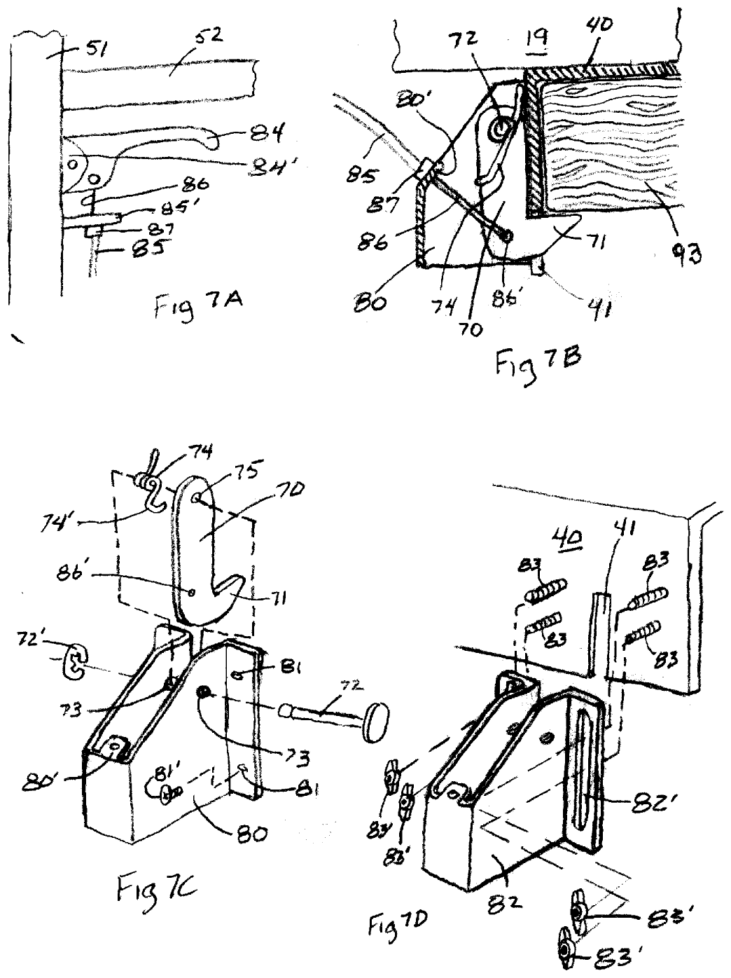

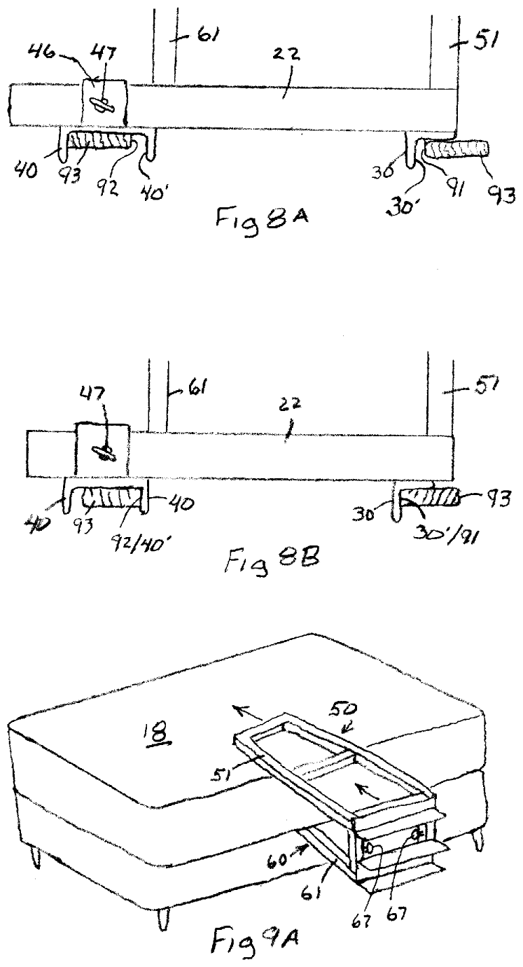

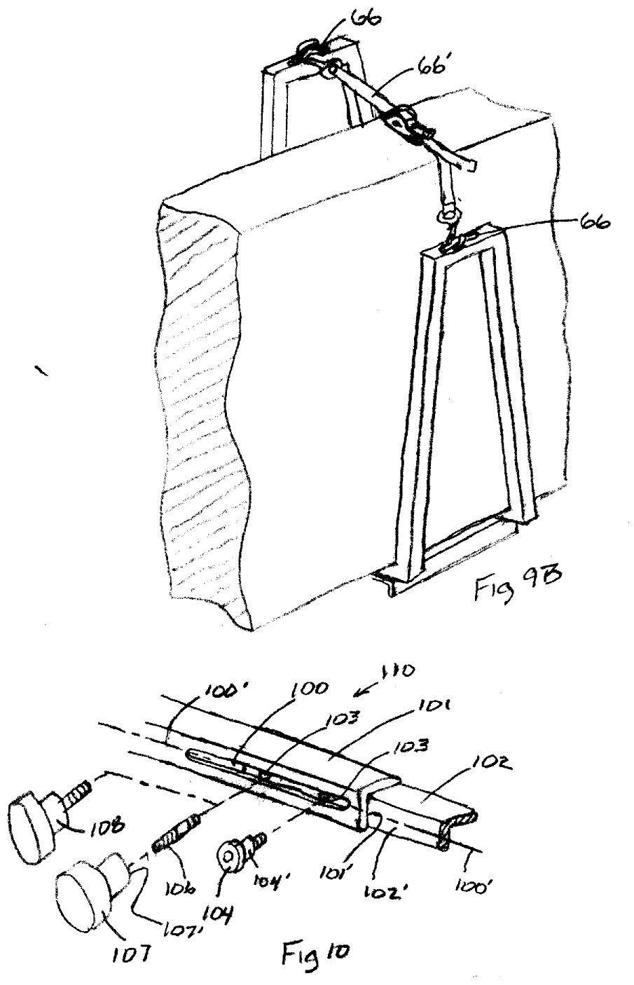

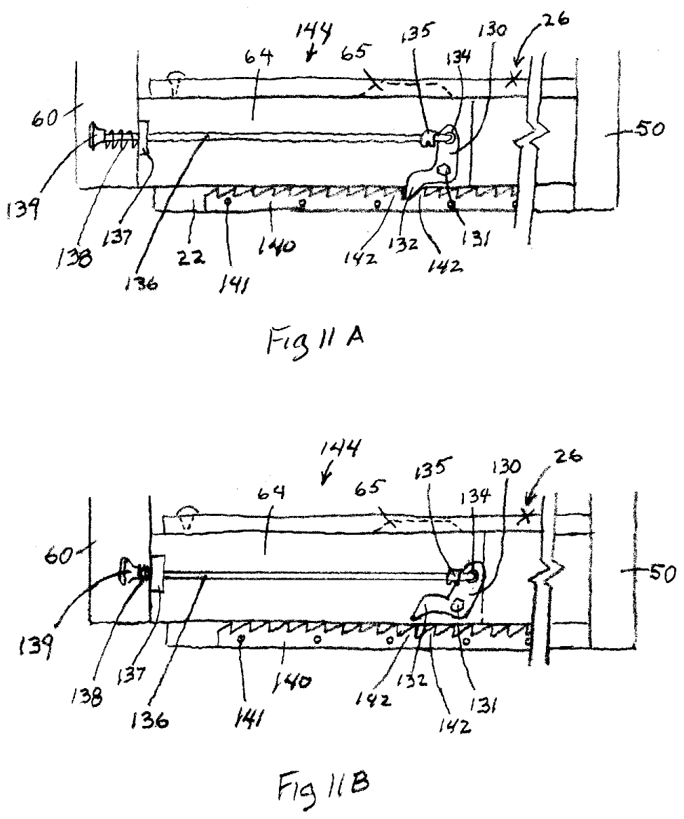

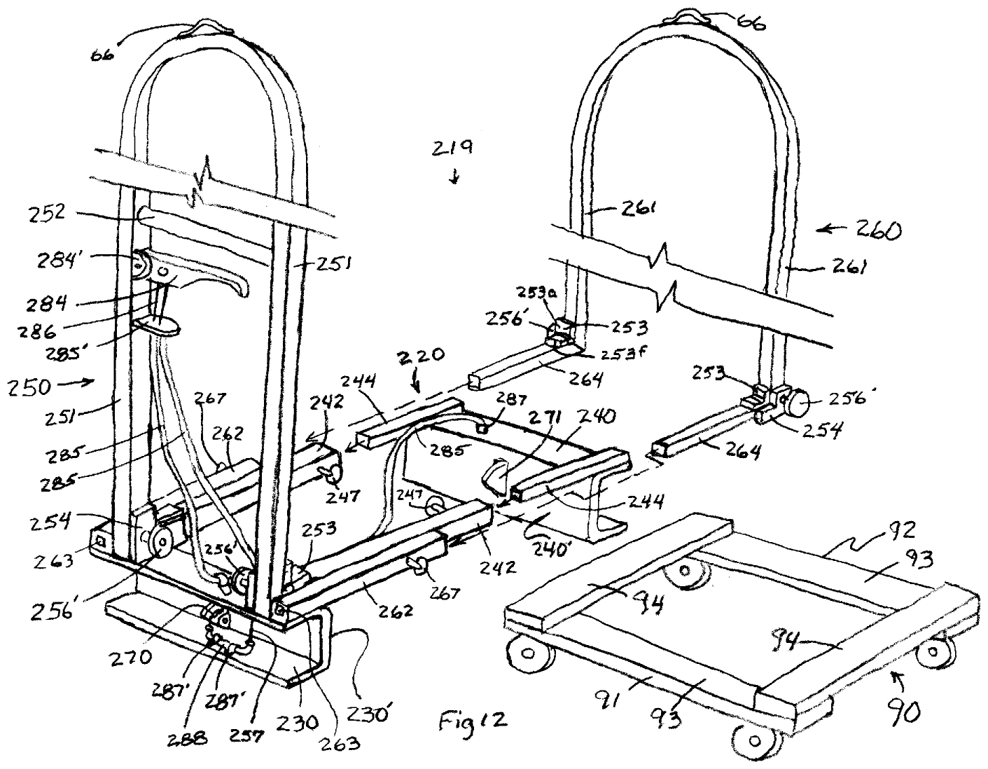

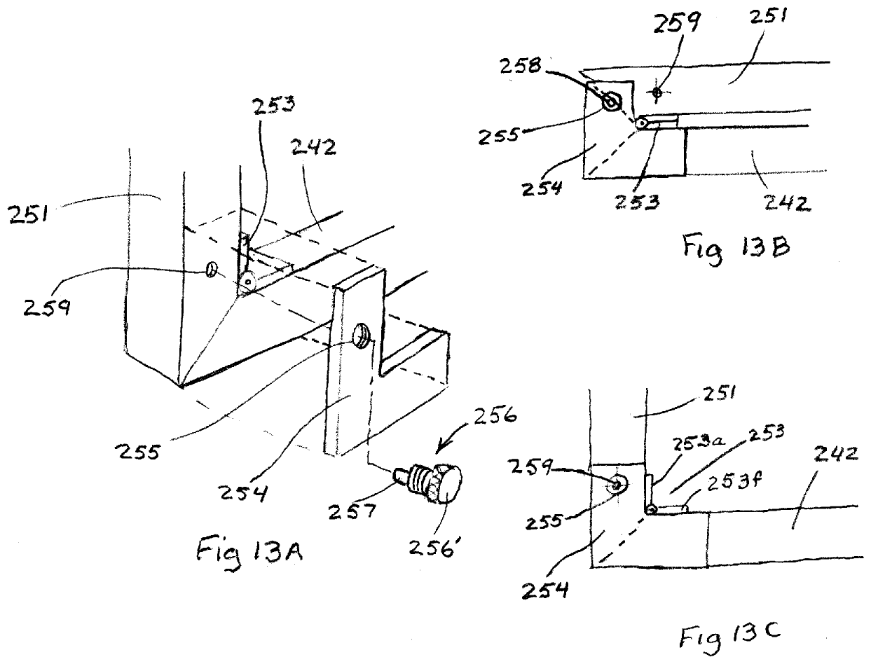

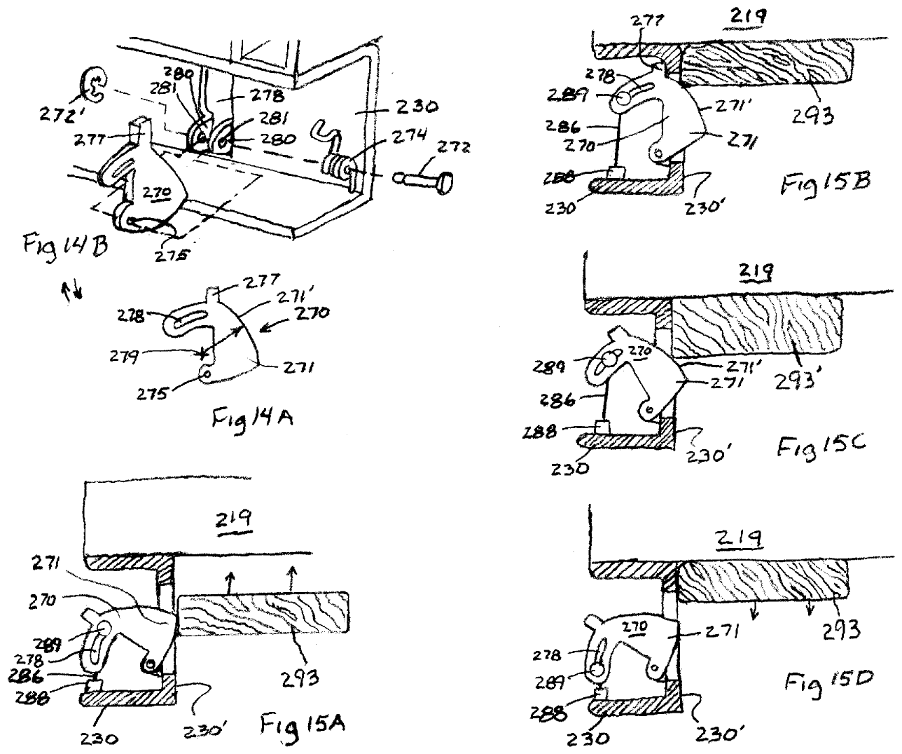

### DETAILED DESCRIPTION—PREFFERED EMBODIMENT—FIGS. 5-8B

Note: The descriptions, methods, and claims presented in this application for use with a mattress are also applicable for use with box spring foundations and other types of mattress foundations. The term “mattress” is used generically in this sense in order to reduce lengthy, redundant nomenclature.

The preferred embodiment of the present invention is shown in FIG. 5. The elements of this embodiment comprise a deck 20, a static engagement or “dolly” boss 30, an adjustable dolly boss 40, a static support truss 50, an adjustable retainer truss 60, and a dolly latch 70.

Deck 20 is shown in FIG. 5 in a deployed, horizontally-referenced orientation and includes structural components of a dimension and material to adequately support a mattress 18 when deck 20 becomes the sole means of support by which a mattress 18 is lifted (as in FIG. 9B). Deck 20 comprises two equal-length, parallel side rails 22 constructed of a strut channel material, such as Unistrut™ brand strut channel, thus providing two support surfaces with a substantially single plane across their top.

Rails 22 are oriented with channels 24 facing one another, as shown, and are of a predetermined length to adequately span a furniture dolly or “F-dolly” 90, as seen in FIG. 12. As a line of reference, deck 20 comprises a longitudinal axis 25 between and parallel to rails 22. This axis is described as an axis across deck 20 wherein a substantial geometric deck symmetry exists on either side. A center-point reference 26 for deck 20 is also defined as a point at the geometric center inside the deck's perimeter.

Rails 22 are held in their relative orientations by rail spreaders. For the preferred embodiment, a static boss 30 is oriented as a rail spreader and is joined at a right angle to rails 22. Static boss 30 is joined to one end of rails 22, as shown. Boss 30 comprises a first contact face 30′ that is capable of a structural communication with a first contact face 91 of F-dolly 90, as in FIG. 8B.

In FIG. 5, an adjustable boss 40 comprises a carrier 46 joined at each of its ends. Carrier 46 is one half of a boss shuttle pair. The boss shuttles of the preferred embodiment are a mated, “carrier and rail” type of dolly shuttle. The boss shuttle, as with every dolly shuttle of the present invention, comprises a static half and an active half. Each half has a profile that is communicatively compatible with its opposite half, so that a movable communication between halves is possible. This movable communication provides an adjustability between components of the mattress dolly, with the orientation of each dolly shuttle ultimately providing a longitudinal movement between components that is parallel to longitudinal axis 25 of deck 20.

Carriers 46 function as active halves and are positioned onto rails 22, with rails 22 functioning as the static halves. In FIG. 6A, carriers 46 are shown as partially wrapping circumferentially around rails 22 so that the socket 23 and channel 24 of rails 22 are unobstructed. This geometric wrapping or “interlocking” of carriers 46 to rails 22 comprises dimensions and tolerances that provide for carriers 46 to be slidably secured adjacent to rails 22 in a working contact. “Working contact” is defined as a contact that allows each shuttle's longitudinal movement, and that provides an adequate degree of precision and stability in that movement.

In FIG. 8B, the orientation and dimensions of adjustable boss 40 are such that a second boss contact face 40′ is parallel to contact face 30′ and is capable of a communication with a second contact face 92 of F-dolly 90 when the mattress dolly 19 is deployed onto F-dolly 90. Boss orientations and dimensions coordinate so that a boss communication with an F-dolly substantially disallows a lateral shift between the mattress dolly and the F-dolly.

FIG. 6A details a shuttle lock with which to lock carrier 46 in a position relative to rails 22. A boss thumbscrew 47 is threaded through a weld nut 28, which is oriented over a bore in carrier 46, so that the thumbscrew's bearing surface 47′ is capable of contacting rail 22.

Due to the orientation of boss 40 being at a right angle to rails 22, it provides a portion of structural integrity for deck 20 as a deck spreader. Because boss 40 is adjustable, it works in tandem with a truss spreader 68 (described below), which is also adjustable. Both spreaders, working together, insure a consistent dimension and “squareness” between rails 22 for a smooth, non-binding operation of each spreader's companion spreader.

In FIG. 5, support truss 50 is joined to one end of deck 20, as shown. Truss 50 comprises two vertical stanchions 51 of adequate strength to support a vertically-oriented mattress 18 that is placed on deck 20 and leaned against truss 50. A rope guide 66 is joined to the top of truss 50. A crossmember 52 also spans between stanchions 51 and is located at a predetermined height so that when an average-sized individual stands erect and grasps the crossmember with arms fully extended downward and to the side, deck 20 is located at a predetermined, optimum working height. A relative orientation of truss 50 is on a first side of a vertically-oriented mattress 18 when mattress 18 is in an upright position on deck 20.

An adjustable retainer truss 60 comprises two truss shuttles. The truss shuttles of this embodiment are a mated “socket and leg” type of shuttle. Two parallel legs 64 each function as an active half, while the sockets 23, channels 24 and rails 22 (by providing sockets 23 and channels 24), function as the static half. FIG. 6B shows legs 64 fitted with leg guides 65. Guides 65 are oriented parallel to legs 64 and have a size relative to the profile of sockets 23 so that when legs 64 are inserted into rails 22, as in FIGS. 6A and 6B, the distal or “guide end” of legs 64 are laterally captive yet longitudinally movable within sockets 23. Screws 27 provide a stop behind guides 65 to retain guides 65 and legs 64 into rails 22 after insertion of legs 64 into rails 22 to a minimum depth of insertion 29.

In FIG. 5, a spreader 68 is joined at a right angle to legs 64. Truss 60 comprises two vertical stanchions 61 attached to spreader 68. A minimum height of truss 60 is a height adequate to retain a bottom edge of mattress 18 in an orientation adjacent to truss 50. A rope guide 66 is joined to the top of truss 60 as a low-profile attachment point for an auxiliary restraining device, such as a ratchet strap 66′ (as in FIG. 9B). A relative orientation of truss 60 is on a second side of a vertically-oriented mattress 18 that is positioned on deck 20.

FIG. 6A details a shuttle lock with which to lock legs 64 and truss 60 in a specific orientation relative to rails 22. A weld nut 28 is welded to leg 64, and a retainer thumbscrew 67 is threaded through nut 28 and through bores in leg 64 so that a bearing surface 67′ of thumbscrew 67 is capable of applying a pressure to rail 22, and so that leg 64 is substantially incapable of movement relative to rail 22.

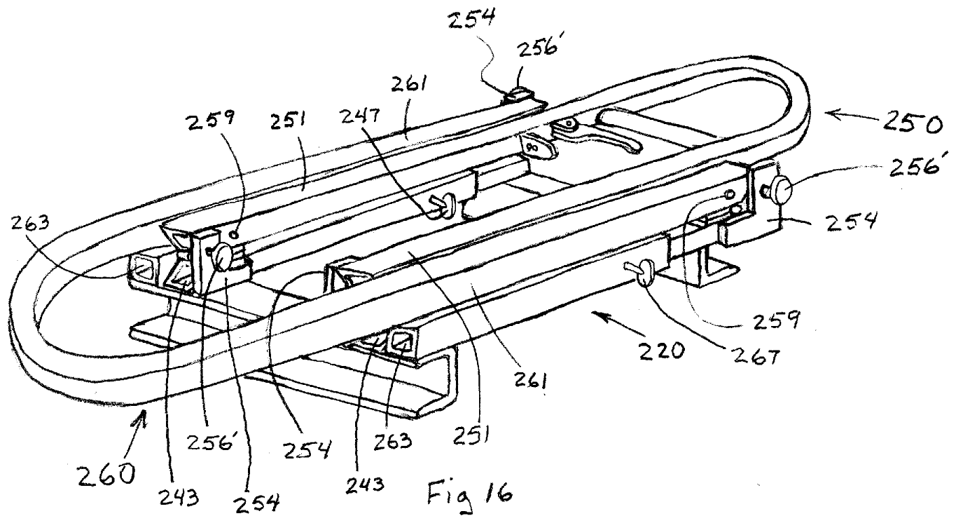

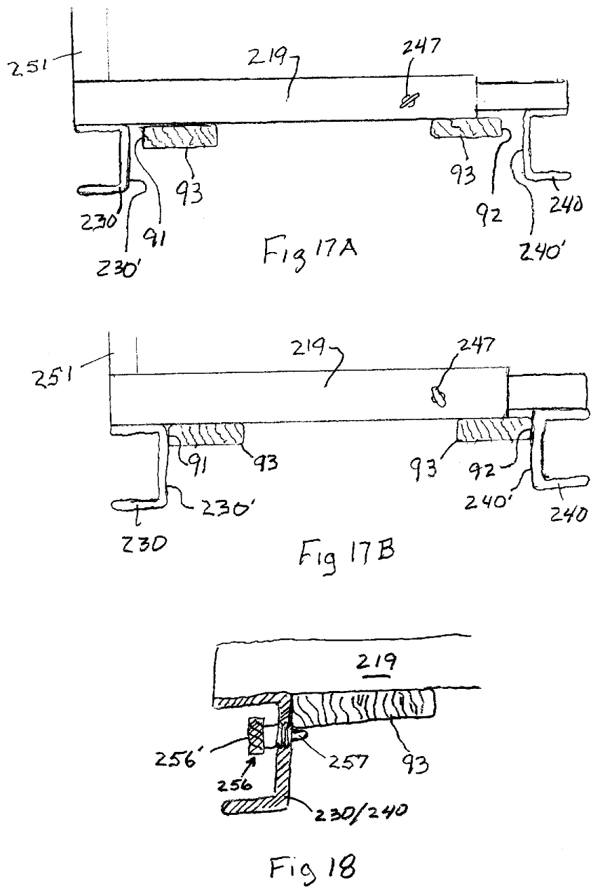

In FIG. 7A, a latch actuator comprises a handle 84, a cable sheath 85 and a cable wire 86. Sheath 85 is mounted to a sheath bracket 85′ by a first sheath terminal 87 mated to bracket 85′. Cable wire 86, inside sheath 85, passes upward through terminal 87 and is operatively joined to handle 84, which is pivotally joined to handle brackets 84′. In FIG. 7B, sheath 85 and wire 86 extend downward from handle 84 to a latch bracket 80 that houses a latch 70. Sheath 85 is joined to a bracket tab 80′ on bracket 80 by a second sheath terminal 87. Wire 86 passes downward in sheath 85 and through terminal 87. Wire 86 is attached to a cable bore 86′ in latch 70.

In FIG. 7B, latch 70 is mounted to bracket 80, and with bracket 80 being mounted to adjustable boss 40 with machine screws 81′ through bracket bores 81. Bracket 80 is joined to boss 40 at an orientation relative to boss 40 so that when mattress dolly 19 is mounted to F-dolly 90, a latch head 71 passes through a latch slot 41 in boss 40 to occupy a space beneath a main rail 93 of F-dolly 90 when latch 70 is at rest, as shown, under tension of a spring 74.

In FIG. 7C, latch 70 is detailed. A pin 72 passes through a first pin bore 73 in bracket 80, through a latch bore 75, through spring 74, through a second pin bore 73, with pin 72 held in place by a snap ring 72′. A hook 74′ on spring 74 is orientated behind and against latch 70 to urge latch 70 toward boss 40, as in FIG. 7B.

### Operation—Preferred Embodiment—FIGS. 5, 8A-9B

In FIG. 8A, boss thumbscrews 47 are loosened and boss 40 is positioned to an orientation so that bosses 30 and 40 are capable of fully seating onto side rails 93 of F-dolly 90 (F-dolly 90 not fully shown). In FIG. 8B, static boss contact face 30′ is positioned adjacent to a first contact face 91 of rail 93. Boss 40 is then moved into an orientation so that adjustable boss contact face 40′ is positioned adjacent to a second contact face 92, as shown. Boss thumbscrews 47 are tightened.

Dolly 19 is now ready to mount to mattress 18. Retainer thumbscrews 67 (seen in FIG. 5) are loosened and truss 60 is adjusted so that truss 60 is at a distance from truss 50 that is equal to or greater than a mattress 18 thickness. Handle 84 is squeezed. Mattress dolly 19 is lifted from F-dolly 90.

Dolly 19 is then slid fully onto mattress 18 as indicated in FIG. 9A. Truss 50 is then pushed downward tightly against mattress 18, and thumbscrews 67 are tightened. Dolly 19 and mattress 18 are tilted into an upright, vertical orientation, as in FIG. 9B. In mounting scenarios where a low retainer truss height is used as a curb to secure a position of a mattress bottom edge against truss 50 and to keep mattress 18 from sliding off of deck 20, mattress 18 may be slid directly onto an upright mattress dolly 19, and with mattress 18 then being lifted into an upright orientation, as above. A ratchet strap 66′ or another restraining device is fastened between rope guides 66 to maintain orientation and stability of mattress 18 against truss 50.

Mattress 18 is now capable of being carried over rough terrain, or re-mounted to F-dolly 90 for stable and secure mattress transport over smooth terrain or greater distances, and with the fully rotatable caster wheels of F-dolly 90 contributing to even greater maneuverability. To re-mount mattress dolly to F-dolly, mattress dolly 19 is positioned onto F-dolly 90 so that bosses 30 and 40 and latch head 71 engage with F-dolly 90 as described.

### DESCRIPTION—Alternative Adjustable Latch Bracket—FIG. 7D

The preferred embodiment shows a dolly latch 70 for latching mattress dolly 19 to F-dolly 90 with a given rail 93 thickness. An adjustable latch bracket 82 accommodates a range of main rail thicknesses. Bracket 82 employs the same latch orientations as described above for FIGS. 7B and 7C. The slots 82′ in bracket 82 fit over studs 83. Bracket 82 is held in place by mini T-handle knobs 83′ threaded onto studs 83.

### Operation—Alternative Adjustable Latch Bracket—FIG. 7C

To adjust the latch position, mattress dolly 19 is placed onto the main rails 93 of F-dolly 90, and boss adjustments are completed as described for the preferred embodiment. Knobs 83′ are then loosened and bracket 82 is moved up or down until latch head 71 is positioned beneath and adjacent to main rail 93 as in FIG. 7B. Knobs 83′ are tightened, and dolly use proceeds as previously described.

### Description—Alternative Dolly Shuttle and Shuttle Lock—FIG. 10

The preferred embodiment details a carrier and rail type of dolly shuttle, and a leg and socket type of dolly shuttle. These shuttles maintain a working contact between shuttle halves by way of mutually compatible geometric profiles capable of movably securing one half to another half by size and shape alone. For materials that are structurally compatible relative to movement and potential proximity to one another but which lack a geometric compatibility between them to maintain a required proximity, auxiliary forms of establishing and maintaining a working contact are possible, including mechanical means. Auxiliary mechanical elements include slots, studs, set screws, grooves, bosses, and detents.

FIG. 10 details a “stud and slot” dolly shuttle 110 in which various mechanical means join two slidably compatible profiles together. “Slidably compatible” is defined as “a potential of separate materials positioned adjacent to one another to maintain a working contact with one another during a longitudinal movement over a specific distance in opposing directions to one another.” Shuttle 110 is joined to members between which an adjustability is desired.

In FIG. 10, a longitudinal slot 100 is oriented through a first sliding surface 101′ of a first sliding material 101 of a slidably compatible pair of materials. The slot's longitudinal axis 100′ is parallel to a longitudinal axis of first material 101, as shown. The length of slot 100 is determined by a desired range of shuttle adjustability. The width of slot 100 is equal to or larger than a bolt body 104′ diameter of a shuttle stud 104. The shuttle stud 104 for this embodiment comprises a shoulder bolt of an adequate size to join the two slidably compatible materials together and facilitate the shuttle's movable communication. Stud 104 is threaded into a threaded stud bore 103 oriented at a specific location in a second sliding surface 102′ of a second sliding material 102. Bore 103 specific location is such that it will align stud 104 with slot 100 when first sliding surface 101′ and second sliding surface 102′ are mated together into a working contact with one another.

In FIG. 10, the profiles of the two sliding materials 101 and 102 are together able to maintain a working contact with one another by using a quantity of one shuttle stud. Some mated profiles, such as two, flat stock sliding members, may require two or more shuttle studs in order to establish and maintain a working contact.

The use of a shuttle stud or studs 104 only facilitates the sliding function but does not provide a locking capability. To provide a shuttle lock feature, a threaded stud 106 is also passed through slot 100 and threaded into a second threaded bore 103 oriented in the same sliding material into which shuttle stud 104 is threaded. A knob 107 is threaded onto stud 106. A flat bearing face 107′ on the slot side or “underside” of knob 107 serves as a point of contact and is positioned against slot 100 so that a tension on the knob 100 is able to draw the sliding members together, and able to make them frictionally resistant to movement relative to one another. Alternately, a knob 108 with external threads may be substituted for a stud 106 and knob 107, as shown in FIG. 10. External threads of knob 108 are threadedly mated with second threaded bore 103 detailed above.

### Operation—Alternative Stud and Slot Dolly Shuttle and Shuttle Lock—FIG. 10

Knob 107 or 108 is loosened. The respective component to which the shuttle is joined and designed to adjust is then adjusted to a desired orientation. Knob 107/108 is then tightened, and mattress dolly use proceeds as described for the preferred embodiment.

### Description—Alternative Ratcheting Shuttle Lock—FIGS. 11a, 11b

FIG. 11A shows a linear ratchet shuttle lock 144 joined to a leg and socket style of dolly shuttle as in the preferred embodiment. A pawl 130 is attached to retainer leg 64 by a shoulder bolt 131 that passes through pawl 130 and is threaded into leg 64 in an orientation as shown. The orientation of pawl 130 communicates with a linear ratchet plate 140 so that the pawl's tooth 132 engages between the teeth 142 of ratchet 140. Ratchet 140 is rigidly joined to the lower edge of strut channel rail 22 with ratchet screws 141, as shown.

A pawl actuator mechanism comprises a rod 136 joined to a bore 134 in pawl 130 with a linkage clip 135. Rod 136 passes from pawl 130 and through a bracket 137 mounted to leg 64. A compression spring 138 is positioned onto rod 136 between bracket 137 and a release knob 139, release knob 139 being mated to rod 136 as shown. Spring 138 is of a predetermined size and strength to provide an expansion force between bracket 137 and knob 139. Expansion of spring 138 is adequate to exert a tension against pawl 130 so that pawl tooth 132 engages between ratchet teeth 142 with a predetermined force. Teeth 142 are cut at an angle so that a free movement of pawl 130 in a direction toward deck center-point 26 is allowed, but also so that a resistance to movement of pawl 130 away from center-point 26 is selectively provided.

The direction of teeth 142 for this truss shuttle application, as shown, is illustrative only. Tooth direction may vary in a boss shuttle application. The required tooth direction for a boss shuttle application is dependent upon an orientation and configuration of the adjustable boss in conjunction with a specific F-dolly configuration. As such, tooth direction and the release rod and knob orientation is determined accordingly.

### Operation—Alternative Ratcheting Shuttle Lock—FIGS. 11A, 11B

In FIG. 11A, to move truss 60 toward truss 50, truss 60 is pushed toward truss 50 until a desired distance between trusses 60 and 50 is obtained. In FIG. 11B, to move truss 60 away from truss 50, knob 139 is depressed toward pawl 130 until pawl tooth 132 disengages from between ratchet teeth 142, as shown. Truss 60 is moved away from truss 50 until desired distance between trusses 50 and 60 is obtained. Knob 139 is then released.

### Description—Alternative Mattress Dolly and Self-Adjusting Latch—FIGS. 12-15d, 17a

The alternative mattress dolly 219 is shown in FIG. 12. This embodiment introduces hinged, folding trusses and a self-adjusting dolly latch embodiment. In FIG. 12, each side rail of deck 220 is formed of two sections of square tubing 242 and 262 being rigidly joined adjacent and parallel to one another, as shown. Rails 242/262 provide the sockets (not seen in this Fig) for the “leg and socket” style of dolly shuttles and also function as the static half of the dolly shuttles. A static dolly boss 230 is rigidly joined to rails 242/262 at a right angle to the rail pair, as shown, and serves as a spreader for deck 220. The length of boss 230 is predetermined to be equal to or less than the length of a main rail 93 between the end rails 94 of F-dolly 90.

At the opposite ends of rail pairs 242/262 from boss 230, an adjustable boss 240 is oriented and functions as a second rail spreader. Boss 240 comprises boss legs 244, which are of equal length and are joined parallel to one another at a right angle to boss 240 at its outer ends, as shown. Legs 244 are specifically oriented in relation to rails 242 so that legs 244 are capable of being inserted into boss sockets 243 (not seen) of rails 242. When mated, rails 242 and legs 244 comprise a combined, adjustable length sufficient to span across F-dolly 90 to rest on main rails 93 as in FIG. 17A. Thumbscrews 247 are threaded into threaded bores in rails 242, in orientations as shown, so that when legs 244 are inserted into sockets 243, a tension on thumbscrews 247 exerts a force against legs 244.

A support truss 250 comprises two vertical stanchions 251 joined together at their tops. A rope guide 66 is mounted at the top of truss 250. A crossmember 252 spans between stanchions 251 and is located at a predetermined height so that when an average-sized human stands crect holding crossmember 252 with arms fully extended downward and to the side, deck 220 is located at a predetermined, optimum working height.

A plurality of hinges 253 are joined at the bottom of support truss 250 and a retainer truss 260. Each hinge 253 is joined to a relevant structure, with the “relevant structure” including deck 220 or a dolly shuttle as described in the preferred embodiment and below. In FIGS. 13A-13C, a hinge construction is detailed for the left stanchion 251 of truss 250. For the remaining stanchions, the hinges and lock components are similar, but are oriented as in FIG. 12.

In FIG. 13A, the joint between stanchion 251 and rail 242 pair is mitered, and mated together by a hinge 253. In FIG. 13C, hinge 253 comprises an active leaf 253a, a fixed leaf 253f, and a hinge barrel through which the hinge leaves are pivotally joined together by a hinge pin. Leaf 53a, the active leaf, is joined to folding truss stanchion 251. For fixed leaf 253f, the relevant structure is deck side rail 242, meaning that leaf 253f is joined to deck 220.

In FIG. 13A, an L-shaped lock plate 254 is oriented adjacent to the hinged pair 251/242. Plate 254 has a profile substantially matching the side profile of the 251/242 pair when stanchion 251 is in an upright, working orientation, as shown. Plate 254 is joined (by acceptable means such as welding, riveting, or bolting) only to rail 242 so that stanchion 251 remains movable. A threaded bore 255 in plate 254 is sized to accept the threaded portion of a spring plunger 256. The position of bore 255 is specifically located as shown in FIG. 13B so that when stanchion 251 is in a folded orientation, a spring plunger nose 257 of plunger 256 extends beneath the mitered portion of stanchion 251 (nose 257 position as indicated by numeral 258) so that stanchion 251 is selectively retained in a folded orientation.

Bore 259 serves as a receiver for nose 257, so the diameter of bore 259 is substantially equal to the outside diameter of nose 257 so that nose 257 is capable of seating into bore 259. The position of bore 259 is concentric with bore 255 when stanchion 251 is in an upright position, as in FIG. 13C.

In FIG. 12, an adjustable retainer truss 260 is used in this embodiment. Two stanchions 261 are joined at their tops to form truss 260, upon which a second rope guide 66 is mounted. Stanchions 261 are joined to legs 264 by hinges 253 between the lower end of each stanchion 261 and the outer end of each leg 264, as shown. Active leaves 253a are joined to folding stanchions 261, and fixed leaves 253f are joined to legs 264, with legs 264 designated as the relevant structure for this embodiment.

Legs 264 are specifically sized and oriented in relation to retainer rails 262 so that legs 264 are capable of being received by retainer sockets 263 of rails 262. Rails 262 and legs 264 comprise a combined adjustable length sufficient to accommodate a given range of mattress thicknesses between truss 250 and truss 260. Thumbscrews 267 are threaded into threaded bores in rails 262, in an orientation as shown, so that when legs 264 are inserted into sockets 263, a tension on thumbscrews 267 exerts a force on legs 264 so that truss 260 is capable of being locked in a position at an orientation relative to truss 250.

Latch actuator components of FIG. 12 transfer a force to a latch head 271, which secures mattress dolly 219 to F-dolly 90. The latch actuator comprises a handle 284, two cable sheaths 285 and two cable wires 286. Sheaths 285 are mounted to a sheath bracket 285′ by sheath terminals 287 mated to the underside of bracket 285′. Cable wires 286, located inside sheaths 285, pass upward through terminals 287 and are operatively joined to handle 284, which is pivotally joined to handle brackets 284′. Sheaths 285 and wires 286 extend downward from handle 284 to two latches 270 mounted to dolly bosses 230 and 240, one latch per dolly boss. Sheath 285 is joined to dolly bosses 230 and 240 by sheath terminals 287. Wires 286 pass through terminals 287, through auxiliary cable guides 288. In FIG. 15B, wire 286 is shown as exiting guide 288 and attaching to a latch slot 278 by way of a slide fitting 289 in latch 270. Fitting 289 provides a movable contact between wire 286 and slot 278.

The preferred embodiment details a dolly latch 70 for securing a mattress dolly 19 to an F-dolly 90 having an F-dolly main rail 93 of a specific thickness. An alternative latch bracket 82 (FIG. 7D) has been described that accommodates variations in F-dolly main rail thicknesses. The present alternative latch 270 provides for rail thickness variations by a different means. In FIG. 14A, a self-adjusting plate latch 270 comprises a latch head 271 having a latch radius center 279 offset from its pivot center, with its pivot center being the center of a latch bore 275. This offset or “eccentric” relationship provides a “cammed” effect that allows for a progressive contact along a vertical plane congruent with boss contact surface 230′, as shown in FIGS. 15B and 15C.

In FIG. 14B, latch brackets 280 are joined to a boss 230 at each side of a latch slot 278, as shown. Brackets 280 are oriented relative to boss 230 so that when mattress dolly 219 is mounted to F-dolly 90, latch head 271 is capable of occupying a space beneath a main rail 293 of F-dolly 90 as in FIG. 15B. A latch pin 272 passes through a spring 274; through a bracket bore 281 in first bracket 280; then through a latch bore 275 of latch 270. A hook in spring 274 is oriented behind latch 270 to urge latch head 271 into slot 278. A latch stop 277 limits a travel of latch 270 into slot 278 (as in FIG. 15B). Pin 272 passes through a second bore 281 in a second latch bracket 280. A snap ring 272′ is placed onto a grooved end of pin 272. Latch components and orientation are identical for boss 240.

FIGS. 15A through 15D show progressive latch orientations. In FIG. 15A, a passive latching orientation is detailed. As mattress dolly 219 and F-dolly main rail 293 are being placed into contact, latch head 271 is pushed aside by rail 293. Sliding terminal 289 remains largely unmoved. In FIG. 15B, dolly 219 and rail 293 are fully seated and rail 293 has passed beyond latch head 271 so that a latch contact edge 271′ is able to contact rail 293. Rail 293 is differentiated as a “thin” rail. Edge 271′ is shown as contacting rail 293 under tension of spring 274 (spring 274 not shown) so that a separation of dolly 219 from rail 293 is precluded. Sliding terminal 289 remains unmoved.

In FIG. 15C, a “thick” rail 293′ is fully seated to dolly 219. Edge 271′ also contacts rail 293′. The communication between edge 271′ of latch 270 and main rails 293 and 293′ comprises an orientation and dimensions so that a separation of dolly 219 from a predetermined range of F-dolly main rail thicknesses is precluded when latch 270 is engaged, as shown. In FIG. 15D, latch head 271 is shown as being manually retracted by sliding terminal 289, as urged by a force applied to attached latch actuator members.

### Operation—Alternative Mattress Dolly and Self-Adjusting Latch—FIG. 16-17B

From a folded orientation as in FIG. 16, all four spring plunger knobs 256′ are pulled away from lock plates 254 until plunger noses 257 are in retracted positions. Knobs 256′ are rotated 90 degrees to lock noses 257 in retracted positions. Retainer truss 260 is raised into a position in which stanchions 261 are at a right angle to deck 220 (as in FIG. 12). The two knobs 256′ on stanchions 261 are then rotated back 90 degrees so that noses 257 enter their bores 59 to secure truss 260 in an upright, working orientation.

Support truss 250 is then raised into a position in which stanchions 251 are at a right angle to deck 220. The two knobs 256′ on stanchions 251 are then rotated back 90 degrees so that noses 257 enter their bores 259 to secure truss 250 in working orientation. Boss thumbscrews 247 are loosened and boss 240 is moved into an orientation so that mattress dolly 219 is capable of fully seating onto F-dolly main rails 93, as in FIG. 17A. (Latches 270 are omitted for detail.)

In FIG. 17B, a static boss contact face 230′ is positioned adjacent to a first contact face 91 of main rail 93. Boss 240 is then adjusted so that boss contact face 240′ is positioned adjacent to a second contact face 92 of a second main rail 93, as shown. Boss thumbscrews 247 are tightened. In FIG. 12, retainer thumbscrews 267 are loosened and truss 260 is adjusted so that truss 260 is at a distance from truss 250 that is equal to or greater than mattress 18 thickness.

Handle 284 is squeezed to retract latch heads 271, and mattress dolly 219 is lifted from F-dolly 90. Dolly 219 is then slid fully onto mattress 18 as in FIG. 9A. Truss 250 is pushed downward against mattress 18, and thumbscrews 267 are tightened. Dolly 219 and mattress 18 are next tilted into an upright, vertical orientation, as in FIG. 9B.

Mattress is now capable of being carried over rough terrain, or re-mounted to F-dolly 90 for stable and secure mattress transport over smooth terrain or for greater distances. To re-mount mattress dolly to furniture dolly, mattress dolly 219 is repositioned onto F-dolly 90 so that bosses 230 and 240 and latches 270 fully engage, as described, with F-dolly 90.

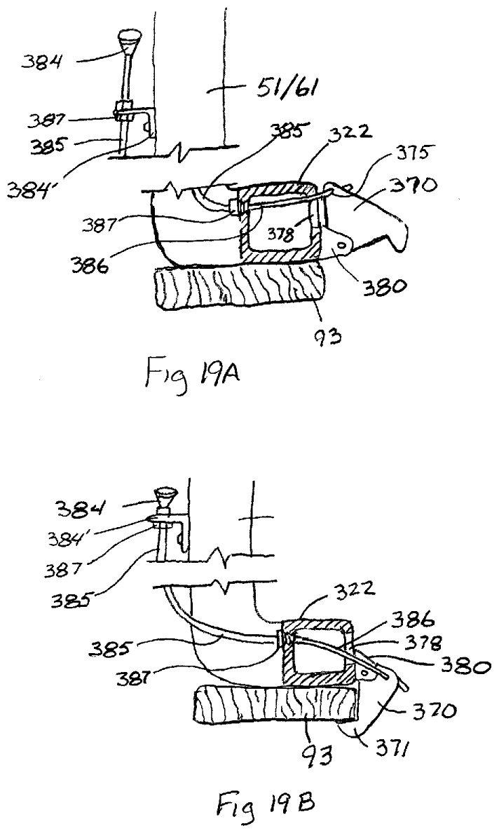

### Description—Spring Plunger Alternative Dolly Latch—FIGS. 18a, 18b

A spring plunger 256 was introduced in a previous embodiment as a hinge lock mechanism. Its use as a dolly lock mechanism is possible, and provides a manufacturing option with fewer parts and a price-point alternative for consumers. Plunger 256 is seen in FIG. 18, and is threaded into a threaded bore of a dolly boss 230/240. An orientation of plunger 256 is at an elevation relative to rail 93 so that plunger nose 257, when extended, occupies a space directly below rail 93, as shown.

### Operation—Spring Plunger Alternative Dolly Latch—FIG. 18

In FIG. 18, dolly 219 is shown as locked to rail 93. To remove dolly 219, knob 256′ is pulled in a direction away from rail 93 so that nose 257 is fully retracted. Knob 256′ is rotated 90 degrees to lock nose 257 in a retracted position. Dolly 219 is lifted from rails 93. Mounting dolly 219 to rails 93 is the reverse of removal.

DESCRIPTION—Alternative Mattress Dolly with Pocket Latch—FIG. 19A

Embodiments of the present mattress dolly have included dolly bosses of varying quantity and configuration. In some applications, a dolly latch may be adequate where a dolly boss may be deemed unnecessary. A pocket latch, as shown in FIG. 19A, provides an option for such a scenario. In a retracted position, all latch components are contained within an area between a plane of the lowest, bottom surface of a mattress dolly 319 and a plane of the top surface 321 of deck 320.

In FIG. 19A, a latch body 370, having a profile as shown, is rotatably joined to latch brackets 380. Brackets 380 are joined to a deck spreader 322. A push-pull cable wire 386 is joined to a latch bore 375 on latch 370. Wire 386 passes through a latch slot 378 in spreader 322, through a sheath terminal 387, and into a cable sheath 385. A cable sheath 385 is joined at a lower cable end to terminal 387. Sheath 385 is joined at an upper cable end to a second terminal 387. Second terminal 387 is joined to a knob bracket 384′. Wire 386 proceeds upward through sheath 385 and through terminal 387 to attach to a push-pull cable knob 384.

For this embodiment, latch activation is accomplished remotely by a force transferred through a cable. Other means of latch activation are possible, including a direct, manual application of force, and a lever-derived application of force. FIGS. 19A and 19B show only one latch. In certain scenarios, one latch may adequately secure dolly 219 to and F-dolly 90. In other scenarios, a additional latches may be required for stable communication between dollies.

Operation—Alternative Mattress Dolly with Pocket Latch—FIGS. 19A, 19B

In FIG. 19A, mattress dolly 319 is shown as positioned on an F-dolly main rail 93. Latch 370 is in a disengaged orientation and knob 384 is in a raised orientation. To engage latch 370 with rail 93, knob 384 is depressed downward toward latch 370 until latch head 371 engages with rail 93, as shown in FIG. 19B. Lift knob 384 to disengage.

### Conclusion, Ramifications, and Scope of Invention

Thus the reader will see that convertible mattress dolly of the invention provides an efficient method for one person to securely handle and transport a mattress or foundation over long distances and difficult terrain; that it is especially helpful in scenarios where no other person is readily available to assist; and that it is compatible with existing furniture moving equipment to provide enhanced versatility of that equipment.

While my above description contains many specificities, these should not be construed as limitations on the scope of the invention, but rather as an exemplification of several embodiments thereof. Many other variations are possible.

For example, the preferred embodiment and the alternative embodiment detail adjustable bosses. The adjustability feature of these bosses provides positive positioning of the mattress dolly onto furniture dollies of varying dimension. This adjustability feature of a dolly boss may be eliminated in cases where the mattress dolly is constructed to be matched with a specific size of furniture dolly where boss adjustability is unnecessary.

The bosses have been described herein in quantities of two. Boss quantities can number as few as one. Such bosses may be constructed as a single square or rectangular shape that communicates with an outer perimeter of a furniture dolly 90, or that communicates with an inner void of a furniture dolly 90 between main rails 93 and end rails 94. Bosses may also be configured to communicate with platform, U-boat, and other auxiliary dollies. As such, a final boss quantity and orientation is largely predetermined by a configuration of each auxiliary dolly.

In FIGS. 9A and 9B, a height of trusses is shown as relative to a size of a mattress. This height relationship is illustrative only. Shorter or taller trusses are possible for either truss in any combination. Trusses having an adjustable height are also possible, with such adjustability accomplished by various means, including telescoping stanchions. Trusses may also present a different profile from those illustrated. For example, a low retainer truss may be constructed of a single section of angle iron or aluminum angle, and a taller truss may comprise a sheet of aluminum or a section of channel iron. As such, truss hinge quantities are predetermined by factors including material choices, market demands for folding trusses, and manufacturing considerations.

The embodiments detailed thus far have described a support truss 50 having a crossmember 52 that can function as a handle. The crossmember is shown as immovably attached to stanchions 51. An adjustable crossmember that can be customized to the user's individual preference is possible. Such adjustment may be accomplished by the use of parallel stanchions and crossmember locking devices including tension knobs, as well as removable or spring-loaded pins in a series of vertical bores. For the preferred embodiment's inward-angled trusses, a telescoping crossmember is also possible. A telescoping action of the crossmember is capable of accommodating a range of crossmember lengths required for vertical reorientation.

Latches have been shown as mounted primarily to dolly bosses. Other latch locations and quantities are possible. Potential, alternate latch orientations between a mattress dolly and furniture dolly are dependent on mattress dolly and furniture dolly configurations.

A self-adjusting plate latch 270 in FIG. 14A is described. The plate latch geometry is illustrative of a cammed action to accommodate a variation in main rail 93 thicknesses. A different geometry to obtain a cammed action for a greater range of main rail thickness is possible. Ridges may also be cut across edge 271′ for even more aggressive holding to rail 93.

Several elements have been described that are capable of providing adjustability between mattress dolly components. As such, the mattress dolly's components capable of being made adjustable and that are made adjustable may be coupled in a single mattress dolly in any operative combination with the mattress dolly's components that are capable of being made adjustable but that are not made adjustable. The elements providing adjustability may also be eliminated in their entirety to create a rigid, non-adjustable mattress dolly.

Accordingly the scope of the invention should be determined not by the embodiments illustrated, but by the appended claims and their legal equivalents.

1. A dolly for assisting with a handling and transport of a mattress by an individual human; said dolly being designated as a mattress dolly comprises a horizontally-referenced deck, a plurality of vertical trusses, and a predetermined quantity of dolly bosses including a quantity of one dolly boss, said predetermined quantity of dolly bosses comprising a quantity to be determined by a range of variables including a furniture dolly configuration;
(a) said deck
(1) comprises a plurality of parallel side rails, said rails
(A) comprising a top surface onto which said mattress is capable of being placed, said top surface comprising a substantially horizontal plane; and
(B) comprising a side rail orientation that is secured by a plurality of rail spreaders; said spreaders being joined to said rails;
(2) comprises a predetermined dimension and material so that said deck is capable of adequately supporting said mattress when said mattress is oriented in a vertical orientation on said deck and said mattress is in a raised position in which said deck is a primary means of support beneath said mattress;
(3) comprises a longitudinal axis, said longitudinal axis being an axis in which a substantial geometric symmetry exists on either side; and
(4) comprises a central point of reference, said central point of reference being a geometric center of said deck;
(b) said trusses
(1) comprise a connection to said deck,
(2) comprise an orientation substantially perpendicular to said deck when said trusses are in an upright, working orientation, and
(3) comprise a support truss and a retainer truss;
(A) said support truss
(i) comprises an orientation on a first side of said mattress when said mattress is vertically orientated on said deck;
(ii) comprises a vertical stanchion, said stanchion being constructed of a material having a size and shape so that said mattress is adequately supported in a vertical orientation, and
(iii) comprises a handle section, said handle section being a section of said truss having a size and shape so that a hand of an average human is capable of grasping; said handle section also comprising an orientation so that said human is capable of lifting and adequately handling said mattress dolly;
(B) said retainer truss
(i) comprises an orientation on a second side of said mattress when said mattress is vertically oriented on said deck; and
(ii) comprises a vertical structure and material capable of adequately retaining a bottom edge of said vertically-oriented mattress adjacent to said support truss when said mattress is positioned on said deck;
(c) said dolly boss being joined to said mattress dolly
(1) comprises a first mating surface capable of a communication with a second mating surface of an auxiliary furniture dolly, and
(2) comprises an orientation relative to said mattress dolly so that when said mattress dolly is in a deployed orientation on said furniture dolly, said communication between said first mating surface of said dolly boss and said second mating surface of said furniture dolly is capable of substantially limiting a lateral shift of said mattress dolly relative to said furniture dolly.

2. The mattress dolly of claim 1 further including a predetermined quantity of dolly shuttles, including a quantity of one dolly shuttle, said predetermined quantity of dolly shuttles being determined by a preferred quantity of adjustable trusses and adjustable bosses; said dolly shuttles comprising a plurality of further designations including a designation as a truss shuttle and a designation as a boss shuttle; said designations being dependent upon a potential connection of an individual dolly shuttle to an adjustable truss, and upon a potential connection of an individual dolly shuttle to an adjustable boss;
(a) each of said dolly shuttles
(1) comprise a structure that is capable of an orientation
(A) between said trusses and said deck, and
(B) between said boss and said deck;
(2) comprise a static half and an active half,
(A) said static half
(i) being joined to said deck, and
(ii) comprising a first profile that is capable of a movable communication with a second profile of said active half;
(B) said active half comprising said second profile that is
(i) capable of said movable communication with said first profile of said static half;
(ii) capable of being joined to said boss; and
(iii) capable of being joined to said trusses;
(C) said static half and said active half being mated together in an orientation relative to one another so that said movable communication is facilitated;
(D) said static half and said active half being mated together into a mated pair so that said first profile and said second profile together comprise a shuttle type from a group of shuttle types, said group of shuttle types comprising a carrier and rail type, a leg and socket type, and a stud and slot type; said carrier and rail type
(i) comprises a carrier and a rail;
(ii) said rail being of a material so that said rail is capable of an adequate support and movement of said carrier;
(iii) said carrier comprising a profile so that said carrier is capable of a sliding movement along a longitudinal axis of said rail;
(iv) said mated pair comprising a contact means for movably securing said carrier in a working contact with said rail,
(v) said contact means including a geometric means and a mechanical means, said geometric means comprising a geometric interlock of a shape of said rail with a shape of said carrier; said shape of said rail and said shape of said carrier together being oriented so that said working contact is facilitated;
(vi) said mechanical means comprising an auxiliary element joined to said dolly shuttle in an orientation so that said working contact is facilitated; said auxiliary elements include a slot, a stud, a set screw, a groove, a boss, and a detent;
said leg and socket type
(i) comprises a leg, and a socket;
(ii) said leg comprising a size and an orientation capable of being inserted into said socket;
(iii) said socket comprising a size and an orientation in which said socket is capable of receiving said leg;
(iv) said leg and socket type also comprising a leg profile and a socket profile from a group of communicatively compatible leg and socket materials including a strut channel material, a square tubing material, a square stock material, a round tubing material, and a round stock material;
said stud and slot type
(i) comprises a mated pair of sliding profiles from a group of communicatively compatible sliding materials,
(ii) said mated pair together comprising a first sliding surface and a second sliding surface;
(iii) said mated pair being slidably joined together by a contact means for movably securing said first sliding surface adjacent to said second sliding surface;
(iv) said contact means including said geometric means and said mechanical means; said mechanical means including a shuttle stud and a shuttle slot; said slot being located in said first sliding surface; said shuttle stud passing through said slot and being joined to said second sliding surface;
(v) said slot comprising an orientation so that said mated pair is capable of said movable communication;
(vi) said shuttle stud also comprising a quantity and orientation that is multiplied as required so that said movable communication is facilitated; each of said dolly shuttles also
(3) comprise an orientation relative to said deck so that said movable communication between said static half and said active half is further capable of providing a longitudinal movement; said longitudinal movement being a movement substantially parallel to said longitudinal axis of said deck so that said adjustable truss is capable of a lateral reorientation relative to said central point of reference of said deck when said adjustable truss is joined to said active half of said truss shuttle, and so that said dolly boss is capable of a lateral reorientation relative to said central point of reference of said deck when said adjustable boss is joined to said active half of said boss shuttle; said active half of said truss shuttle being joined to said adjustable truss; said active half of said boss shuttle being joined to said adjustable boss.

3. The dolly shuttles of claim 2 further including a shuttle lock, said shuttle lock comprising a restraint member and a shuttle lock actuator,
(1) said restraint member
(A) comprising a restraint surface,
(B) being movably joined to said mattress dolly by a predetermined structure, said predetermined structure being determined by a type of said restraint member, and comprising an orientation to said mattress dolly so that said restraint surface is capable of contacting said dolly shuttle;
(2) said shuttle lock actuator
(A) comprising a connection to said restraint member and
(B) comprising a structure capable of receiving and transferring a force so that said restraint surface is capable of being selectively urged into a selective engagement and disengagement with said dolly shuttle so that said longitudinal movement is selectively allowed and selectively disallowed.

4. The dolly shuttles of claim 3 wherein said restraint member comprises a thumbscrew, said restraint surface comprises a bearing point, and said shuttle lock actuator comprises a thumbscrew thumb pad,
(1) said thumbscrew
(A) comprising said bearing point,
(B) being rotatably joined to said mattress dolly by a threaded bore, said threaded bore comprising an orientation in said active half of said dolly shuttle so that said bearing point is capable of contacting said static half of said dolly shuttle;
(2) said thumb pad
(A) comprising a connection to said bearing point, and
(B) comprising a structure capable of receiving and transferring a force to said bearing point so that said bearing point is capable of being selectively urged into said engagement and said disengagement with said static half so that said longitudinal movement is selectively allowed and selectively disallowed.

5. The dolly shuttles of claim 3 wherein said restraint member comprises a thumbscrew, said restraint surface comprises a bearing point, and said shuttle lock actuator comprises a thumbscrew thumb pad,
(1) said thumbscrew
(A) comprising said bearing point,
(B) being rotatably joined to said mattress dolly by a threaded bore, said threaded bore comprising an orientation in said static half of said dolly shuttle so that said bearing point is capable of contacting said active half of said dolly shuttle;
(2) said thumb pad
(A) comprising a connection to said bearing point, and
(B) comprising a structure capable of receiving and transferring a force to said bearing point so that said bearing point is capable of being selectively urged into said engagement and said disengagement with said active half so that said longitudinal movement is selectively allowed and selectively disallowed.

6. The dolly shuttles of claim 2 further including a shuttle lock; said shuttle lock comprising
(1) a longitudinal slot, a threaded bore, and a knob with external male threads;
(A) said slot
(i) comprises a location through said first sliding surface of said mated pair;
(ii) comprises a slot size so that said slot is capable of receiving said external male threads of said knob;
(iii) comprises a central axis substantially parallel to said longitudinal axis of said deck; and that
(iv) comprises a slot orientation so that said central axis of said slot is oriented in an alignment with a bore center of said threaded bore;
(B) said threaded bore
(i) comprising said bore center;
(ii) comprising an orientation in said second sliding surface of said mated pair,
(iii) comprising a bore size and a thread pitch capable of receiving said external male threads, and
(iv) comprising a bore orientation so that said external male threads are capable of simultaneously occupying said slot and being threadedly mated to said threaded bore;
(C) said knob comprising a bearing face point of contact, said bearing face being oriented against said slot so that a rotational force exerted on said knob is capable of drawing and tightening said second sliding surface against said first sliding surface so that said static half and said active half are substantially limited from a movement in relation to one another.

7. The dolly shuttles of claim 2 further including a shuttle lock; said shuttle lock comprising a pawl, a linear ratchet, and a lock actuator
(1) said pawl
(A) being pivotally joined to said first profile of said mated pair of said shuttle halves;
(B) being oriented relative to said linear ratchet so that a tooth of said pawl is capable of fully mating with said linear ratchet;
(2) said linear ratchet
(A) being joined to said second profile of said mated pair;
(B) comprising a series of ratchet teeth having vertical leading edges and inclined trailing edges;
(C) comprising a direction of free movement and a direction of selective movement;
(i) said direction of free movement being a movement in which said pawl freely passes over said ratchet teeth;
(ii) said direction of selective movement being a direction in which said pawl tooth engages with said ratchet teeth to create a restriction to said movement;
(D) said pawl and said linear ratchet being oriented together so that said restriction to said movement is capable of being selectively negated by an application of force to lift said pawl tooth to an orientation above said ratchet teeth;
(3) said lock actuator
(A) comprising a linkage rod, said linkage rod
(B) comprising a first end a and a second end;
(i) said first end comprising a rod bracket through which said first end is oriented, a knob at said first end of said rod′ and a spring oriented onto said rod between said rod bracket and said knob; said rod bracket being mounted to said first profile
(ii) said second end being joined to said pawl, said second end joined to said pawl at an orientation so that a bias of said spring pulls said pawl tooth into contact with said linear ratchet.

8. The mattress dolly of claim 1 further including a dolly latch,
(a) said dolly latch being joined to said mattress dolly comprises a latch head, and a latch actuator;
(1) said latch head (A) comprising a shape capable of a movable communication with said furniture dolly, said movable communication comprising an engagement and a disengagement,
(i) said engagement comprising a communication between said latch head and said furniture dolly so that when said mattress dolly is mated to said furniture dolly, said latch head is in an orientation to create a barrier so that said mattress dolly is substantially resistant to a removal from said furniture dolly;
(ii) said disengagement comprising an orientation of said latch head in relation to said furniture dolly so that said barrier is withdrawn so that said mattress dolly being mated to said furniture dolly is capable of said removal from said furniture dolly without an interference from said latch head; and
(B) comprising an orientation so that said shape of said latch head is capable of said movable communication with said furniture dolly;
(2) said latch actuator
(A) comprising a linkage joined to said latch head, said linkage
(B) comprising a shape and orientation capable of receiving a force exerted by said human, and
(C) comprising a shape and orientation capable of transferring said force exerted by said human to said latch head so that said latch head is urged into an orientation of said engagement and into an orientation of said disengagement with said furniture dolly.

9. The dolly latch of claim 7 wherein said latch head comprises a spring plunger nose and said latch actuator comprises a spring plunger knob.

10. The dolly latch of claim 7 wherein said latch actuator comprises a spring, a push-pull cable, and a cable knob;
(A) said spring being joined to said latch head so that said spring exerts a force on said latch head so that said latch head is urged into an orientation of said engagement with said furniture dolly;
(B) said push-pull cable comprising a cable wire and a cable sheath;
(i) said cable sheath comprising an orientation between said latch head and said cable knob;
(ii) said cable sheath also comprising a sheath fastener, said sheath fastener having a contact with said cable sheath so that said cable sheath is secured against a movement at a termination point of the cable sheath ends;
(iii) said cable wire being slidably inserted into said cable sheath, said cable wire being joined to said latch head so that a force exerted on said cable wire transfers a force to said latch head so that said latch head is urged into an orientation of said disengagement with said furniture dolly;
(C) said cable knob being joined to said cable wire so that said human is able to exert a force on said cable wire so that said cable wire transfers said force to said latch head.

11. The mattress dolly of claim 2 further including a predetermined quantity of hinges including a quantity of one hinge, and a hinge lock means for locking said hinges into an upright orientation, said predetermined quantity of hinges being determined by a number of hinges required for a preferred quantity of said vertical trusses to be hinged including a hinge quantity required to adequately hinge one of said trusses, and a hinge quantity required to hinge both said support truss and said retainer truss;
(a) said hinges comprising
(1) an active leaf, said active leaf being joined to a lower end of a hinged truss;
(2) a fixed leaf, said fixed leaf being joined to a relevant structure from a choice of relevant structures, said choice of relevant structures including
(A) said deck, and
(B) said active half of said dolly shuttle;
(3) a hinge barrel, said hinge barrel comprising a common axis to which said fixed leaf and said active leaf are pivotally joined;
(4) an orientation so that said hinges are capable of a folding action in which said hinged truss is capable of being repositioned from a vertical, working orientation and into a horizontal, folded orientation parallel to said deck;
(b) said hinge lock means being joined to said hinges and comprising a plurality of hinge lock components arranged in a predetermined orientation so that
(1) an engagement of said lock means secures said trusses into an upright, vertical orientation, and so that
(2) a disengagement of said lock means releases said trusses so that said trusses are capable of being reoriented into a horizontal orientation.

12. A method of removing a mattress from a bed and moving said mattress with a furniture dolly comprising the steps of
(a) providing a mattress dolly, said mattress dolly having a horizontal deck, a plurality of vertical trusses, and a dolly boss;
(b) providing a furniture dolly;
(c) lifting said mattress dolly;
(d) orienting a first truss of said mattress dolly into a horizontal orientation;
(e) sliding said first truss beneath said mattress so that a second truss is above said mattress and said deck contacts said mattress;
(f) sliding said mattress in a direction of said mattress dolly to a position so that said mattress is capable of tilting and contacting a floor surface on which bed sits;
(g) tilting said mattress to contact said floor;
(h) tilting said mattress into an upright orientation onto said deck of said mattress dolly;
(i) lifting said mattress dolly and said mattress; and
(j) placing said mattress dolly onto said furniture dolly so that said dolly boss engages with said furniture dolly.

13. A dolly for assisting with a handling and transport of a mattress by an individual human; said dolly being designated as a mattress dolly comprises a horizontally-referenced deck, a plurality of vertical trusses, and a predetermined quantity of a dolly latches including a quantity of one dolly latch;
(a) said deck
(1) comprises a plurality of parallel side rails, said rails
(A) comprising a top surface onto which said mattress is capable of being placed, said top surface comprising a substantially horizontal plane; and
(B) comprising a side rail orientation that is secured by a plurality of rail spreaders; said spreaders being joined to said rails;
(2) comprises a predetermined dimension and material so that said deck is capable of adequately supporting said mattress when said mattress is oriented in a vertical orientation on said deck and said mattress is in a raised position in which said deck is a primary means of support beneath said mattress;
(3) comprises a longitudinal axis, said longitudinal axis being an axis in which a substantial geometric symmetry exists on either side; and
(4) comprises a central point of reference, said central point of reference being a geometric center of said deck;
(b) said trusses
(1) comprise a connection to said deck,
(2) comprise an orientation substantially perpendicular to said deck when said trusses are in an upright, working orientation, and
(3) comprise a support truss and a retainer truss;
(A) said support truss
(i) comprises an orientation on a first side of said mattress when said mattress is vertically orientated on said deck;
(ii) comprises a vertical stanchion, said stanchion being constructed of a material having a size and shape so that said mattress is adequately supported in a vertical orientation, and
(iii) comprises a handle section, said handle section being a section of said truss having a size and shape so that a hand of an average human is capable of grasping; said handle section also comprising an orientation so that said human is capable of lifting and adequately handling said mattress dolly;
(B) said retainer truss
(i) comprises an orientation on a second side of said mattress when said mattress is vertically oriented on said deck; and
(ii) comprises a vertical structure and material capable of adequately retaining a bottom edge of said vertically-oriented mattress adjacent to said support truss when said mattress is positioned on said deck;
(c) said dolly latch being joined to said mattress dolly comprises a latch head, and a latch actuator;
(1) said latch head
(A) comprising a shape capable of a movable communication with said furniture dolly, said movable communication comprising an engagement and a disengagement,
(i) said engagement comprising a communication between said latch head and said furniture dolly so that when said mattress dolly is mated to said furniture dolly, said latch head is in an orientation to create a barrier so that said mattress dolly is substantially resistant to a removal from said furniture dolly;
(ii) said disengagement comprising an orientation of said latch head in relation to said furniture dolly so that said barrier is withdrawn so that said mattress dolly being mated to said furniture dolly is capable of said removal from said furniture dolly without an interference from said latch head; and
(B) comprising an orientation so that said shape of said latch head is capable of said movable communication with said furniture dolly;
(2) said latch actuator
(A) comprising a linkage joined to said latch head, said linkage
(B) comprising a shape and orientation capable of receiving a force exerted by said human, and
(C) comprising a shape and orientation capable of transferring said force exerted by said human to said latch head so that said latch head is urged into an orientation of said engagement and into an orientation of said disengagement with said furniture dolly.
